(19) United States
(12) Patent Application Publication
(10) Pub. No.: US 2009/0006785 A1
(43) Pub. Date: Jan. 1, 2009

(54) APPARATUS, METHOD AND SYSTEM FOR COMPARING SAMPLE DATA WITH COMPARISON DATA

(75) Inventors: Christoph Bilger, Muenchen (DE); Rex Kho, Holzkirchen (DE); Achim Schramm, Muenchen (DE); Martin Maier, Diessen (DE); Yann Zinzius, Unterhaching (DE); Armin Kohlhase, Neubiberg (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 11/769,874

(22) Filed: Jun. 28, 2007

(51) Int. Cl. G06F 12/00

(52) U.S. Cl. 711/156; 711/E12.016

(57) ABSTRACT

An apparatus, method and system for comparing sample data with comparison date is disclosed. One embodiment provides a plurality of storage locations, an interface coupled to a plurality of storage locations for an exchange of data between the plurality of storage locations and external circuitry coupled to the interface, and a data comparator for comparing comparison data stored in the plurality of storage locations and sample data.

### SUMMARY

One embodiment includes a storage apparatus, method and system for comparing sample data with comparison date is disclosed. One embodiment provides a plurality of storage locations, an interface coupled to a plurality of storage locations for an exchange of data between the plurality of storage locations and external circuitry coupled to the interface, and a data comparator for comparing comparison data stored in the plurality of storage locations and sample data.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a schematic representation of an integrated memory device according to an embodiment.

FIG. 2 illustrates a schematic representation of a memory module according to an embodiment.

FIG. 3 illustrates a schematic representation of a memory module according to an embodiment.

FIG. 4 illustrates a schematic representation of an electronic system according to an embodiment.

FIG. 5 illustrates a schematic representation of a plug-in-card according to an embodiment.

FIG. 6 illustrates a schematic representation of a main-board according to an embodiment.

FIG. 7 illustrates a schematic flow chart of a method for comparing according to an embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

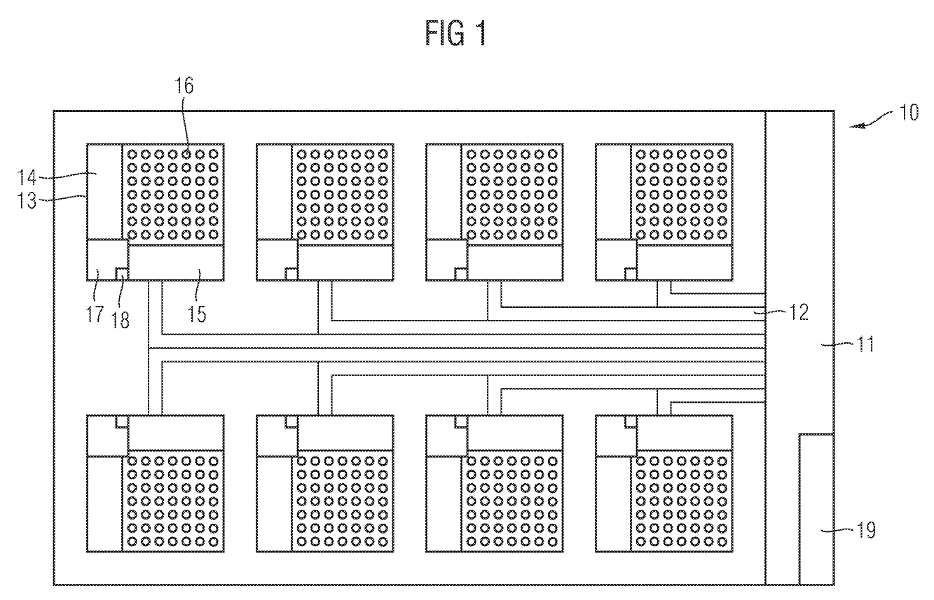

FIG. 1 illustrates a schematic representation of an integrated memory device 10 in accordance with one embodiment. The memory device 10 includes a plurality of storage locations. The integrated memory device 10 is subdivided in a number of subdivisions 13. These subdivisions 13 are for example banks or blocks. Each subdivision 13 includes a group of storage locations. A main purpose of the memory device 10 is storing data.

The integrated memory device 10 includes an interface logic or interface circuit 11 including an input 19 and control and data inputs not displayed in FIG. 1. The input 19 is at least one of an address input receiving address information, or address signals, a data input receiving data, or data signals, and a control input receiving control commands, or control signals. The input can be dedicated for merely one of these purposes. As an alternative, the input is configured to receive both address and data signals or both address and control signals or both data and control signals or both address, data and control signals. The input can be provided and configured for a communication based on packages or frames with a complex protocol.

The integrated memory device 10 can be coupled to an external bus or to other external circuitry via the interface circuit 11. For this purpose, the interface circuit 11 may include input and output amplifiers, latches, buffers etc. The interface circuit 11 is coupled to the subdivisions 13 by an internal bus 12. In FIG. 1, the bus 12 is, in an exemplary way, displayed by a number of point-to-point connections each connecting one of the subdivisions and the interface circuit 11.

Each subdivision 13 includes an address decoder 14 receiving, from the interface circuit 11 via the bus 12, an address indicating a storage location. As an example, each storage location includes a predefined number of memory cells 16.

Each subdivision 13 further includes a predefined number of sense amplifiers 15. As an example, addresses are addresses of word lines, a storage location includes the memory cells 16 coupled to one word line, the number of memory cells coupled to one word line equals the number of sense amplifiers 15, and, when the address decoder 14 activates one of the word lines, each memory cell 16 coupled to the word line is connected to one of the sense amplifiers 15. However, each sub-division can be organized in a way and provide a topology different from the schematic representation displayed in FIG. 1, for example with or without word lines, with or without sense amplifiers, with or without bit lines and with or without address decoders.

Furthermore, each subdivision 13 includes a data comparator 17 with a sample memory 18. The data comparator 17 is controlled via the bus 12 and sample data are written to the sample memory 18 via the bus 12. Each sample comparator 17 is configured to compare sample data stored in the sample memory 18 with comparison data stored in the memory cells 16 of the subdivision 13 associated with the data comparator. For this purpose, the size or storage capacity of the sample memory 18 of each data comparator 17 is adapted to the typical size of sample data (a few bytes to a few hundred bytes, sometimes even more). Typically, the amount of comparison data is larger than the amount of sample data. As an alternative to the separation of the storage locations for the comparison data and the sample memory for the sample data, both can be integrated. In particular, the sample memory can be a predefined part or sub-set of the entirety of storage locations of the respective subdivision 13, or any group of storage locations within the entirety of storage locations can be used as sample memory.

The geometry, the number and size of the elements and their relative arrangement in the integrated memory device 10 displayed in FIG. 1 are merely exemplary. Additional elements can be provided. Lines providing and distributing electrical power, clock signals, control signals and other signals are not displayed in FIG. 1.

The integrated memory device 10 is for example configured as a main memory for a computer or as a graphics memory of a plug-in graphics card for a computer etc. The term “computer” refers to a desktop computer, a laptop computer, a palmtop computer, a workstation, a mainframe computer or any other kind of computer. In these and other applications, the integrated memory device 10 stores executable code, data and other information. The memory cells 16 can be SRAM-, DRAM- or other volatile memory cells or flash-, MRAM-, FRAM-, PCRAM-, CBRAM-, ROM-, EPROM-, EEPROM or other non-volatile memory cells.

Any kind of digital information can be written to or read from any storage location of the integrated memory device 10. An address signal is received by the integrated memory device 10 via the input 19 of the interface circuit 11. From the received address, the interface circuit 11 evaluates to which subdivision 13 and to which storage location within this subdivision information is to be written or from which subdivision and from which storage location within this subdivision 13 information is to be read. The interface circuit 11 transmits an internal address to the respective subdivision 13, wherein the internal address identifies the storage location within the respective subdivision 13. The address decoder 14 of the respective subdivision 13 decodes the internal address and selects the storage location identified by the internal address, for example by activating the respective word line. Information transferred from the interface circuit 11 to the subdivision 13 via the bus 12 is written to the selected storage location by the sense amplifiers 15, or information read from a storage location by the sense amplifiers 15 is transferred to the interface circuit 11 via the bus 12.

Information stored in the integrated memory device 10 can be compared with sample data. For example, all occurrences of the sample data in the data stored in the integrated memory device 10 are to be found. In these cases, the information stored in the integrated memory device 10 is called comparison data. As an alternative, the information stored in the integrated memory device 10 can be called gallery data, wherein the term “gallery data” is not restricted to data representing pictures, images or videos.

The sample data is received from external circuitry by the interface circuit 11. Via the bus 12, the interface circuit 11 transfers the sample data to the sample memory 18 of the data comparator 17 of one or several selected subdivisions 13 or to the sample memories 18 of the data comparators 17 of each of the subdivisions 13. Each data comparator 17 compares the sample data stored in the sample memory 18 with the comparison data stored in the respective subdivision 13. When the sample data occurs in the comparison data once or several times, the data comparator 7 transfers the address of the occurrence or the addresses of the occurrences to the interface circuit 11 via the bus 12.

The data, or information, stored in the subdivisions 13 of the integrated memory device 10 can be one or several texts, one or several pictures or images, video data, music or other sound, a database containing any kind of information, or any other data or information. The data comparators can be optimized for a particular type or a particular group of types of information. As an alternative, the data comparator 17 can be configured for the comparison of any type of data, or information. The data comparators are configured or can be configured to indicate any identical occurrence of the sample data in the comparison data. As an alternative, the data comparators 17 are configured or can be configured to indicate similarities beyond identity, too.

The above described comparison of the comparison data stored in the integrated memory device 10 with the sample data can be used to search for any occurrence of the sample data or similar data within the comparison data. This search can be performed on all the data, or information, stored in the integrated memory device 10 by all the data comparators 17.

As an alternative, the comparison data includes only a part of the entire amount of data stored in the integrated memory device 10. In this case, the search can be conducted merely by those data comparators 17 associated with subdivisions 13 storing the comparison data or parts of the comparison data. As an alternative, the search is conducted on all the data stored in the entire memory device 10, and merely occurrences within the relevant comparison data are considered.

In the embodiment described above with reference to FIG. 1, each data comparator 17 is assigned to and associated with one of the subdivisions 13. Therefore, any electrical or optical lines, lenses, mirrors or other communication channels between the data comparators 17 and the associated subdivisions 13 can be rather short, facilitating high data transfer rates. As an alternative, the data comparators 17 are arranged separate from the subdivisions 13. As a further alternative, each data comparator 17 is not or not exclusively assigned to merely one of the subdivisions 13. In this case, a number of data comparators can search for one sample data or for a number of different sample data within the same subdivision 13 or within the same group of subdivisions 13.

As already mentioned above, the number of subdivisions 13 and the number of data comparators 17 can be different from those displayed in FIG. 1. In particular, an alternative integrated memory device provides merely one data comparator and any number of subdivisions 13. As a further alternative, the integrated memory device 10 is not subdivided into subdivisions 13 and provides one data comparator or a number of data comparators.

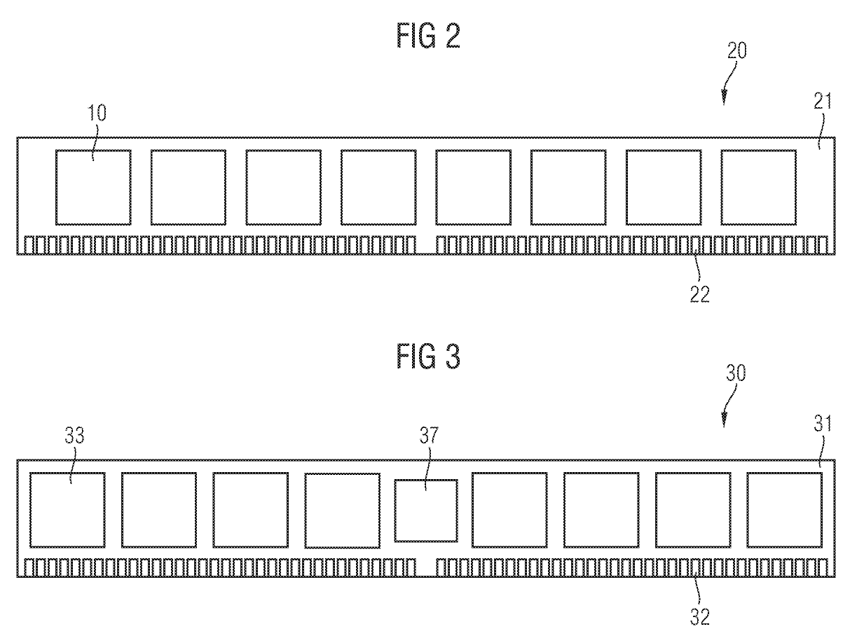

FIG. 2 displays a schematic representation of a memory module 20. The memory module 20 includes a printed circuit board 21. A number of integrated memory devices 10 as described above with reference to FIG. 1 (including the alternatives and variance described above) are arranged on the printed circuit board 21. A number of electrical contacts 22 are arranged along (at least) one edge of the printed circuit board 21 on one or both sides of the printed circuit board 21. Controller, buffer or other integrated circuits can be provided on the printed circuit board 21, too, although they are not displayed in FIG. 2. Conductors connect the electrical contacts 22 to the circuits and devices provided on the printed circuit board 21. Additionally or alternatively, optical wave guides, a lens, a mirror or other communication channels are provided at the printed circuit board 21. In this case, an optical interface can be provided, too.

The memory module 20 and the integrated memory devices 10 at the memory module 20 are configured to form the main memory of a desktop computer, a laptop computer, a palmtop computer, a workstation, a mainframe computer or any other computer. As an alternative, the memory module 20 is configured to be part of any other information technology device.

FIG. 3 displays a schematic representation of a memory module 30 including a printed circuit board 31. A number of electrical contacts 32 are arranged along (at least) one edge of the printed circuit board 31 at one or both sides of the printed circuit board 31. A number of integrated memory devices 33 are arranged at one or both sides of the printed circuit board 31. Contrary to the embodiment described above with reference to FIG. 2, the integrated memory devices 33 of the memory module 30 are not provided with data comparators as described above with reference to FIG. 1. Rather, a data comparator 37 is provided as a separate integrated device at the printed circuit board 31.

Again, the integrated memory devices 33, the data comparator 37 and the electrical contacts 32 or an optical interface or any other interface are coupled to each other by at least one of electrical conductors, an optical waveguide, a lens, a mirror or an other type of communication channel. Similar to the memory module 20 described above with reference to FIG. 2, the memory module 30 described with reference to FIG. 3 can be configured to be used with any kind of computer or any other information technology device.

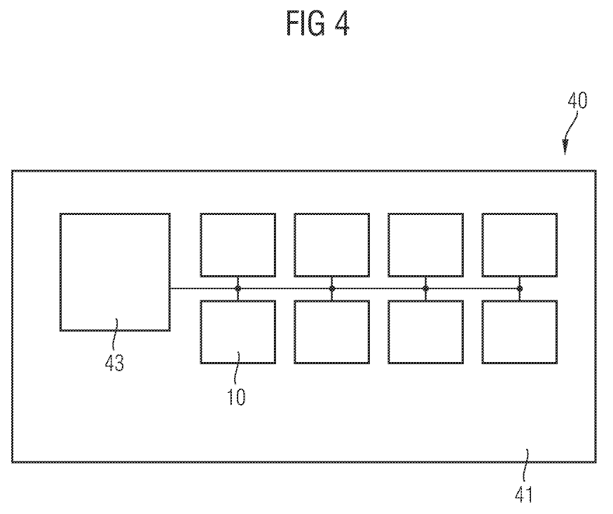

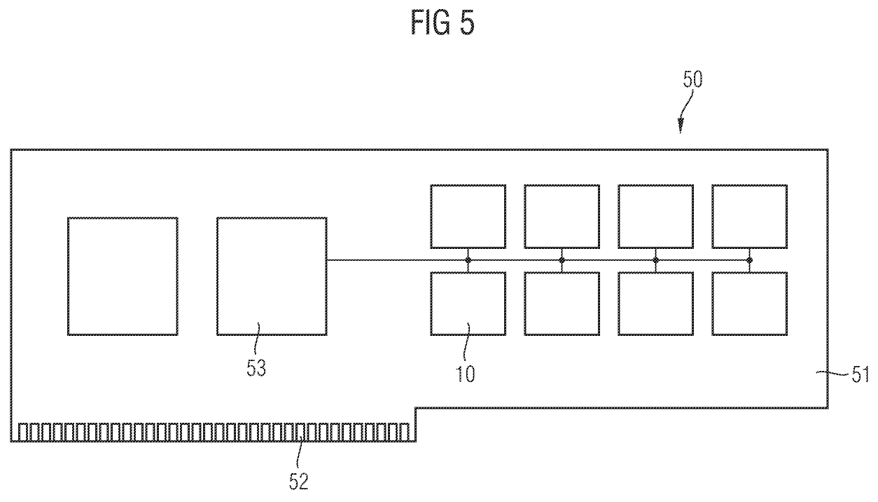

FIG. 4 is a schematic representation of an electronic system 40 including a printed circuit board 41. An integrated circuit 43 or a number of integrated circuits and a number of integrated memory devices 10 (one or several integrated memory devices 10) are arranged at the printed circuit board 41. The integrated memory device 10 or the integrated memory devices 10 and the integrated circuit 43 or the integrated circuits are coupled to each other via electrical conductors or additionally or alternatively via an optical waveguide, a lens, a mirror or any other communication channels. The electronic system is for example any kind of computer or a part of a computer or any other information technology device or a part of any kind of information technology device.

FIG. 5 displays a schematic representation of a plug-in card 50 including a printed circuit board 51. One or several integrated circuits 53 and one or several integrated memory devices 10 are arranged at the printed circuit board 51. A number of electrical contacts 52 are provided at an edge or a part of an edge of the printed circuit board 51 on one or both sides of the printed circuit board 51.

The printed circuit board 51 is provided for being inserted into a slot or for being coupled to any other coupling member at an electronic device, wherein the slot or coupling member is provided for inserting a plug-in card like the plug-in card 50 displayed in FIG. 5. When the plug-in card 50 is inserted into the slot, or coupled to the coupling member, the electrical contacts 52 form electrically conductive connections between the plug-in card 50 and the electronic device. The integrated circuit or circuits 53 and the integrated memory device or devices 10 and the electrical contacts 52 are coupled to each other via at least one of electrical conductors, optical waveguides and other communication channels. Alternatively to or additionally to the electrical contacts 52, an optical interface or any other interface may be provided.

The plug-in card 50 is for example a graphics card, a sound card or any other plug-in card providing a special functionality for a computer.

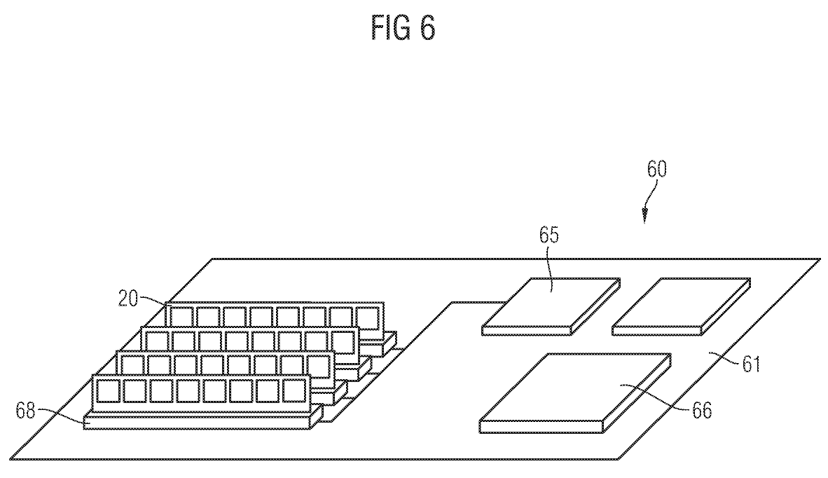

FIG. 6 is a schematic representation of a main board 60 for a desktop computer, a laptop computer, a palmtop computer, a mainframe computer, or any other kind of computer or any other information technology device. The main board 60 includes a printed circuit board 61. A memory controller 65, a central processing unit or any other kind of processor 66 and other integrated devices may be provided at the printed circuit board 61. A number of memory module slots 68 are provided. Memory modules 20 as described above with reference to FIG. 2 can be inserted into the memory module slots 68. Alternatively or additionally, memory modules 30 as described above with reference to FIG. 3 can be inserted into the memory module slots 68. The central processing unit 66, the memory controller 65, other integrated devices and the memory module slots 68 are coupled to each other by at least one of electrical conductors, optical waveguides and other kinds of communication channels.

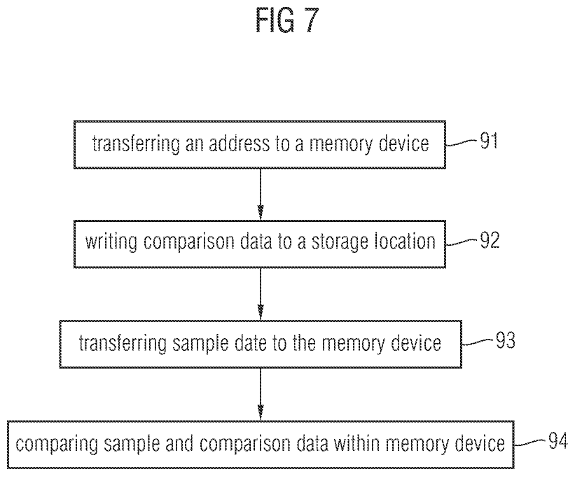

Whenever particular sample data are searched for in comparison data stored in one or several memory devices 10 or memory modules 20, 30 of the electronic system 40 or the plug-in card 50 or the main board 60, the comparison of the sample data and the comparison data is performed by the data comparators 17 of the integrated memory devices 10 or by the data comparator 37 of the memory module 30 as outlined above with reference to the FIGS. 1 and 3. The comparison or search can be performed in a process as will be described below with reference to FIG. 7.

FIG. 7 is a schematic flow chart of a method for comparing sample data with comparison data. This method can, for example, be conducted in an integrated memory device 10 or in a memory module 20 or 30 as described above with reference to FIGS. 1 to 3.

In a first process 91, an address is transferred to the memory device. The address is transferred from circuitry which is external to the memory device, to an input of the memory device. In a second process 92, comparison data are written to a storage location within the memory device wherein the address identifies the storage location. The first process 91 and the second process 92 are a particular example for a procedure of writing comparison data to the memory device. The external circuitry provides at least the address. Optionally, the external circuitry also provides the comparison data. In this way, the writing procedure is controlled by the external circuitry.

When the comparison data are already present in the memory device, the first process 91 and the second process 92 can be omitted. In all cases, the results of the fourth process 94 are optionally transferred to external circuitry in a fifth process 95.

In a third process 93, sample data are transferred to the memory device. In a fourth process 94, the sample data and the comparison data are compared within the memory device. In particular, the sample data and the comparison data are compared by a data comparator within the memory device. When the memory device includes a number of data comparators, the fourth process 94 can be conducted by each of the number of data comparators simultaneously. Each of the number of data comparators compares the sample data with a part, or subset, of the comparison data. In this case, the third process 93 includes transferring the sample data to each of the number of data comparators. As an alternative, a number of different sample data are transferred to the data comparators in the third process 93. Thereafter, the different sample data are compared with the same parts or with different parts of the comparison data simultaneously in the fourth process 94.

When the method described above with reference to FIG. 7 is conducted in one of the embodiments described above with reference to FIGS. 1 to 6, the memory device is for example the integrated memory device 10 described above with reference to FIG. 1, the memory module 20 described above with reference to FIG. 2 or the memory module 30 described above with reference to FIG. 3. Each of the external circuitry providing the address to the memory device, the external circuitry providing the comparison data to the memory device, the external circuitry providing the sample data to the memory device and the external circuitry receiving the results of the comparison can be for example the integrated circuit 43 of the electronic system 40 described above with reference to FIG. 4, or the integrated circuit 53 of the plug-in card 50 described above with reference to FIG. 5, or the integrated circuit 63 or the memory controller 65 or the central processing unit 66 of the main board 60 described above with reference to FIG. 6. Some or all of the external circuitry providing the address, the external circuitry providing the comparison data, the external circuitry providing the sample data and the external circuitry receiving the results of the comparison can be identical or different from each other.

At least some of the processes of the method described above with reference to FIG. 7 can be conducted by using a memory device including means for receiving comparison data at the memory device, means for receiving sample data at the memory device, and means for comparing, within the memory device, the sample data with the comparison data stored in the memory device.

Further means may be provided, for example means for storing the comparison data in the memory device. As an example, the means for receiving comparison data at the memory device and, if provided, the means for storing the comparison data can be implemented in an interface coupled to a memory core of the memory device or to any other means for storing data within the memory device. This interface is configured for being coupled to external circuitry, for example to a memory buffer component, to a memory controller or to a processor.

Furthermore, means for receiving sample data can be provided. The means for receiving sample data can be identical to the means for receiving the comparison data. In other words, means for receiving both comparison data and sample data may be provided. As an alternative, means for receiving comparison data can be different from means for receiving sample data.

The memory device may include a number of sections, or units, or subdivisions, each of which includes means for storing comparison data and means for comparing the sample data with the comparison data stored in the corresponding or any other means for storing comparison data.

The preceding description describes exemplary embodiments of the invention. The features disclosed therein and the claims and the drawings can, therefore, be useful for realizing the invention in its various embodiments, both individually and in any combination. While the foregoing is directed to embodiments of the present invention, other and further embodiments of this invention may be devised without departing from the basic scope of the invention, the scope of the present invention being determined by the claims that follow.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An apparatus comprising:
a plurality of storage locations;
an interface coupled to the plurality of storage locations, for an exchange of data between the plurality of storage locations and external circuitry coupled to the interface; and
a data comparator for comparing comparison data stored in the plurality of storage locations and sample data.

2. The apparatus of claim 1, further comprising an input receiving, from circuitry external to the memory device, an address indicating a storage location out of the plurality of storage locations.

3. The apparatus of claim 1, wherein the memory device is configured for a management of the plurality of storage locations by external circuitry.

4. The apparatus of claim 1, wherein the memory device is a main memory for a computer.

5. The apparatus of claim 1, wherein the memory device comprises a plurality of data comparators.

6. The apparatus of claim 5, wherein each of the plurality of data comparators is assigned to a group of storage locations.

7. The apparatus of claim 5, wherein the plurality of storage locations comprises several distinct groups of storage locations, and each group of storage locations is assigned to one of the plurality of data comparators.

8. The apparatus of claim 5, wherein each of the plurality of data comparators comprises a sample memory storing sample data.

9. The apparatus of claim 2, wherein the memory device comprises a plurality of data comparators.

10. The apparatus of claim 9, wherein each of the plurality of data comparators is assigned to a group of storage locations.

11. The apparatus of claim 9, wherein the plurality of storage locations comprises several distinct groups of storage locations, and each group of storage locations is assigned to one of the plurality of data comparators.

12. The apparatus of claim 9, wherein each of the plurality of data comparators comprises a sample memory configured for storing sample data.

13. The apparatus of claim 1, wherein the memory device is an integrated memory device.

14. The apparatus of claim 1, wherein the apparatus is a memory device.

15. The apparatus of claim 1, wherein the apparatus is a memory module.

16. A System comprising an apparatus, the apparatus comprising:
a plurality of storage locations;
an interface coupled to the plurality of storage locations, for an exchange of data between the plurality of storage locations and external circuitry coupled to the interface; and
a data comparator for comparing comparison data stored in the plurality of storage locations and sample data.

17. The system of claim 16, wherein the apparatus is a memory device.

18. The system of claim 17, the system further comprising:
a memory controller coupled to the memory device; and
a processor coupled to the memory controller.

19. A method for comparing sample data with comparison data, the method comprising:
transferring the sample data to a memory device;
comparing, in a data comparator within the memory device, the sample data with the comparison data stored in the memory device.

20. The method of claim 19, further comprising:
controlling the process of comparing by circuitry external to the memory device.

21. The method of claim 19, further comprising:
writing, controlled by circuitry external to the memory device, the comparison data to the memory device.

22. The method of claim 21 wherein the process of writing comprises transferring an address from the external circuitry to the memory device and writing the comparison data to a storage location identified by the address.

23. The method of claim 19, wherein each of several parts of the comparison data are stored in one of several groups of storage locations, and the process of comparing comprises simultaneously comparing, in each of a plurality of data comparators within the memory device, the sample data with one of the parts of the comparison data.

24. A memory device comprising:
means for receiving comparison data at the memory device;
means for receiving sample data at the memory device;
means for comparing, within the memory device, the sample data with the comparison data stored in the memory device.
